(19) United States
(12) Patent Application Publication
(10) Pub. No.: US 2018/0233955 A1
(43) Pub. Date: Aug. 16, 2018

(54) WIRELESS POWER TRANSMITTER

(71) Applicant: Samsung Electro-Mechanics Co., Ltd., Suwon-si (KR)

(72) Inventors: Seung Won PARK, Suwon-si (KR); Sang Ho CHO, Suwon-si (KR); Hyo Young KIM, Suwon-si (KR); Eun Young SHIN, Suwon-si (KR); Young Seung ROH, Suwon-si (KR)

(73) Assignee: Samsung Electro-Mechanics Co., Ltd., Suwon-si (KR)

(21) Appl. No.: 15/817,805

(22) Filed: Nov. 20, 2017

(30) Foreign Application Priority Data
Feb. 15, 2017 (KR) 10-2017-0020560
Jul. 26, 2017 (KR) 10-2017-0094878

(51) Int. Cl. H02J 50/12; H02J 7/02; H02M 7/537

(52) U.S. Cl. CPC H02J 50/12; H02M 7/537; H02J 7/025

(57) ABSTRACT

A wireless power transmitter includes: a converter including a first switch and a second switch, and configured to output alternating current (AC) power to an AC node between the first switch and the second switch; a common resonance capacitor connected to the AC node; and resonators connected to the common resonance capacitor, wherein each of the resonators includes a series capacitor, a resonance coil, and a sub-switch, connected to each other in series, and wherein the resonance coil is configured to transmit the power in a non-contact manner.

### CROSS-REFERENCE TO RELATED APPLICATIONS

This application claims benefit under 35 U.S.C. § 119(a) of Korean Patent Application Nos. 10-2017-0020560 and 10-2017-0094878 filed on Feb. 15, 2017 and Jul. 26, 2017, respectively, in the Korean Intellectual Property Office, the entire disclosures of which are incorporated herein by reference for all purposes.

### BACKGROUND

### 1. Field

The following description relates to a wireless power transmitter.

### 2. Description of Related Art

Wireless power charging technology, which is capable of charging an electronic device with power, even when the electronic device and a charging source are not in contact with each other, has been commercialized, and a market for a wireless power transmitter for wirelessly transmitting power has been expanded.

In order to smoothly perform wireless charging, a resonance coil of the wireless power transmitter and a receiving coil of a wireless power receiver should be positioned to correspond to each other. Therefore, in order to wirelessly provide power more smoothly, the wireless power transmitter may provide a wider chargeable area by providing multiple resonance coils.

In a case in which multiple resonance coils are used as described above, however, since any one resonance coil may influence other resonance coils, and inverter circuits for supplying an alternating current (AC) to the resonance coils should be configured, production costs may be increased.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a filter module includes: a first substrate and a second substrate coupled to each other to form an internal space; a first filter formed on the first substrate, in the internal space, and including a bulk acoustic resonator; and a second filter disposed on the second substrate, wherein the first and second filters are configured to filter frequencies within different bands.

In one general aspect, a wireless power transmitter includes: a converter including a first switch and a second switch, and configured to output alternating current (AC) power to an AC node between the first switch and the second switch; a common resonance capacitor connected to the AC node; and resonators connected to the common resonance capacitor, wherein each of the resonators includes a series capacitor, a resonance coil, and a sub-switch, connected to each other in series, and wherein the resonance coil is configured to transmit the power in a non-contact manner.

The converter may further include an inductor including one terminal connected to input power and another terminal connected to the AC node and an output capacitor comprising one terminal connected to the second switch.

The converter may further include an output diode connecting the one terminal of the inductor and the one terminal of the output capacitor to each other.

The converter may include another terminal of the output capacitor connected to the one terminal of the inductor.

The series capacitor may include a capacitance that is at least 10 times greater than a capacitance of the common resonance capacitor.

An operational temperature range of the common resonance capacitor may be wider than an operational temperature range of the series capacitor.

A rate of change of capacitance according to temperature of the common resonance capacitor may be lower than a rate of change of capacitance according to temperature of the series capacitor.

The converter may be configured to be operated in a soft start mode in which an on-duty of the first switch is gradually increased at a time of an initial operation.

The common resonance capacitor may have a temperature rate of change of capacitance of 0±30 ppm/° C. and an operational temperature range of −55° C. to 125° C., and the series capacitor may have an operational temperature range of −55° C. to 85° C., and a temperature rate of change of capacitance of ±15%.

In another general aspect, a wireless power transmitter includes: an inductor connected between input power and an alternating current (AC) node; a first switch connected between the AC node and a ground; a second switch connected between the AC node and an output terminal; a common resonance capacitor including one terminal connected to the AC node; and resonators connected to another terminal of the common resonance capacitor, wherein each of the resonators includes a resonance coil configured to transmit power in a non-contact manner and a series capacitor.

The resonator may further include a sub-switch configured to control the resonance coil.

Each of the resonators may further include two sub-switches configured to control the resonance coil. The two sub-switches may be configured to operate as a full-bridge circuit together with the first switch and the second switch.

Each of the resonators may further include a back-to-back switch configured to block a current circulated to the resonance coil when the sub-switch is turned off.

The series capacitor may have a capacitance that is at least 10 times greater than a capacitance of the common resonance capacitor.

An operational temperature range of the common resonance capacitor may be wider than an operational temperature range of the series capacitor.

A rate of change of capacitance according to temperature of the common resonance capacitor may be lower than a rate of change of capacitance according to temperature of the series capacitor.

The first switch may be configured to be operated in a soft start mode in which an on-duty is gradually increased when the input power is applied.

The common resonance capacitor may have a temperature rate of change of capacitance of 0±30 ppm/° C. and an operational temperature range of −55° C. to 125° C., and the series capacitor may have an operational temperature range of −55° C. to 85° C., and a temperature rate of change of capacitance of ±15%.

Other features and aspects will be apparent from the following detailed description, the drawings, and the claims.

### BRIEF DESCRIPTION OF DRAWINGS

FIG. 1 is a view illustrating an example of a wireless power transmitting system including a wireless power transmitter.

FIG. 2 is a circuit diagram illustrating a wireless power transmitter, according to an embodiment.

FIG. 3 is a circuit diagram illustrating a wireless power transmitter, according to another embodiment.

FIG. 4 is a circuit diagram illustrating a wireless power transmitter, according to another embodiment.

FIG. 5 is a circuit diagram illustrating a wireless power transmitter, according to another embodiment.

FIG. 6 is a circuit diagram illustrating a wireless power transmitter, according to another embodiment.

FIG. 7A is a graph illustrating a current circulating in a resonance coil.

FIG. 7B is a graph illustrating a current circulating in the resonance coil of the wirelessly power transmitter, according to an embodiment.

FIG. 8 is a circuit diagram illustrating a converter, according to an embodiment.

FIG. 9 is a circuit diagram illustrating a converter, according to another embodiment.

FIG. 10 is a circuit diagram of a wireless power transmitting system, according to an embodiment.

FIG. 11 is a graph illustrating an output voltage of the converter and an output voltage of a wireless power receiver, according to an embodiment.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when an element, such as a layer, region, or substrate, is described as being “on,” “connected to,” “coupled to,” “over,” or “covering” another element, it may be directly “on,” “connected to,” “coupled to,” “over,” or “covering” the other element, or there may be one or more other elements intervening therebetween. In contrast, when an element is described as being “directly on,” “directly connected to,” “directly coupled to,” “directly over,” or “directly covering” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms such as “above,” “upper,” “below,” and “lower” may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

The features of the examples described herein may be combined in various ways as will be apparent after an understanding of the disclosure of this application. Further, although the examples described herein have a variety of configurations, other configurations are possible as will be apparent after an understanding of the disclosure of this application.

Hereinafter, embodiments will be described in detail with reference to the accompanying drawings.

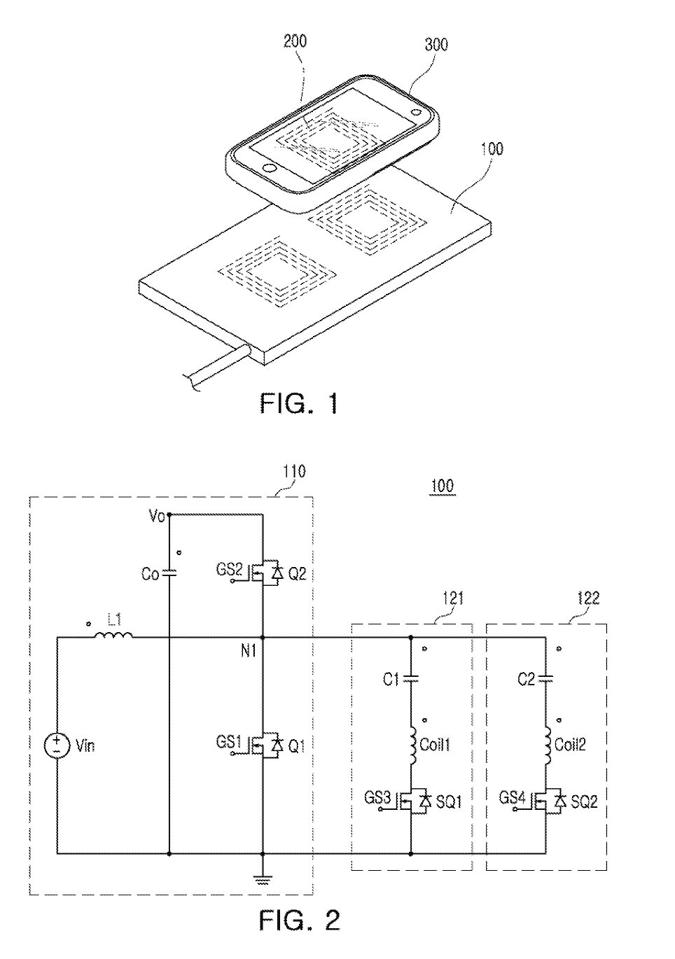

FIG. 1 is a view illustrating an example of a wireless power transmitting system including a wireless power transmitter 100 and a wireless power receiver 200.

Referring to FIG. 1, the wireless power receiver 200 may be adjacent to the wireless power transmitter 100 to be magnetically coupled (e.g., magnetically resonate with or magnetically induced) to the wireless power transmitter 100, thereby wirelessly receiving power.

The wireless power receiver 200 provides the received power to an electronic device 300. The wireless power receiver 200 may be a component within the electronic device 300, or may be a separate device connected to the electronic device 300.

Although the wireless power receiver 200 and the wireless power transmitter 100 are partially spaced apart from each other in the illustrated example, this positioning is merely illustrative, and the wireless power receiver 200 and the wireless power transmitter 100 may be in contact with each other or may be adjacent to each other.

The wireless power transmitter 100 includes resonance coils. Therefore, the wireless power receiver 200 may be magnetically coupled to the wireless power transmitter 100 at any position on the wireless power transmitter 100.

Hereinafter, the wireless power transmitter 100 and variations thereof, according to various embodiments, will be described in detail with reference to FIGS. 2 through 11.

FIG. 2 is a circuit diagram illustrating the wireless power transmitter 100, according to an embodiment.

Referring to FIG. 2, the wireless power transmitter 100 includes a converter 110, and first and second resonators 121 and 122. Hereinafter, it will be assumed that the wireless power transmitter 100 includes two resonators such as the first resonator 121 and a second resonator 122. This is an assumption for convenience of explanation; however, the wireless power transmitter 100 may also include three or more resonators.

Further, the first resonator 121 includes a resonance capacitor C1 and the second resonator 122 includes a resonance capacitor C2.

The converter 110 includes a first switch Q1 and a second switch Q2 that configure a half-bridge circuit. The first switch Q1 is turned on or off by a first gate signal GS1 and the second switch Q2 is turned on or off by a second gate signal GS2. Further, the converter 110 includes an inductor L1 having one terminal connected to an input power Vin and another terminal connected to a node between the first switch Q1 and the second switch Q2.

Further, the converter 110 includes an output capacitor Co connected to the second switch Q2. The output capacitor C0 accumulates charges by switching operations of the first switch Q1 and the second switch Q2, and reduces a ripple of an output voltage Vo.

The converter 110 boosts a voltage in a method of charging the inductor L1 with a current using the input power Vin by the first switch Q1 and the second switch Q2 that alternately operate, and transmitting the current to the output terminal. Specifically, when the first switch Q1 is turned on and the second switch Q2 is turned off, the inductor L1 is charged with the current. Further, when the first switch Q1 is turned off and the second switch Q2 is turned on, counter electromotive force occurs in the inductor L1, and the voltage generated by the inductor L1 is added to a voltage of the input power Vin to be transmitted to the output terminal. That is, the output voltage VO is a boosted voltage that the input power Vin is boosted by the converter 110. Further, an alternating current (AC) voltage generated by the converter 110 is output to a first node N1.

That is, the converter 110 converts direct current (DC) power provided from the input power Vin into AC power, and provides the converted AC power to the first and second resonators 121 and 122 through the first node N1.

Therefore, the converter 110 simultaneously performs a function of a boost converter that boosts the input voltage to the boosted voltage and a function of an inverter that converts a DC voltage into the AC voltage. Specifically, the switching elements Q1 and Q2, the output capacitor C0, and a first coil L11 are operated as the boost converter. Further, the switching elements Q11 and Q12 are also operated as the inverter. In other words, the converter 110 includes a boost inverter having a form in which the boost converter and the inverter that commonly use the switching elements Q11 and Q12 are coupled to each other.

The input power Vin is, for example, direct current (DC) power generated using power which is input from an outside source. For example, the input power Vin is power having a predetermined level of voltage (e.g., a voltage of 5V) which is converted by an adaptor receiving a commercial AC voltage.

The first resonator 121 includes a first resonance coil Coil1 that includes a first resonance capacitor C1 and transmits power in a non-contact manner, and a first sub-switch 501. Similarly, the second resonator 122 includes a second resonance coil Coil2 that includes a second resonance capacitor C2 and transmits the power in the non-contact manner, and a second sub-switch SQ2. Further, the first sub-switch SQ1 is turned on or off by a third gate signal GS3 and a second sub-switch SQ2 is turned on or off by a fourth gate signal GS4.

The first resonator 121 and the second resonator 122 are connected to a first node between the first switch Q1 and the second switch Q2 of the converter 110. The first resonator 121 and the second resonator 122 are supplied with the AC voltage from the first node N1. Therefore, the first node N1 may be referred to as an AC node.

For example, in a case in which the first resonator 121 is operated to wirelessly transmit the power, the converter 110 applies the AC voltage to one terminal of the first resonator 121, and the sub-switch SQ1 of the first resonator 121 is turned on. Accordingly, the alternating current flows in the resonance coil Coil1, and the power is wirelessly radiated from the resonance coil Coil1.

The first switch Q1 and the second switch Q2 may be metal oxide silicon field effect transistor (MOSFET) switches, and the first sub-switch SQ1 and the second sub-switch SQ2 may also be MOSFET switches.

Further, each of the MOSFET switches may include a diode. Such a diode may prevent the switch from being damaged by counter electromotive force when controlling a capacitive load.

As such, since the wireless power transmitter 100 provides the AC power to the resonators by implementing the boost inverter without reducing the output voltage, production costs may be reduced.

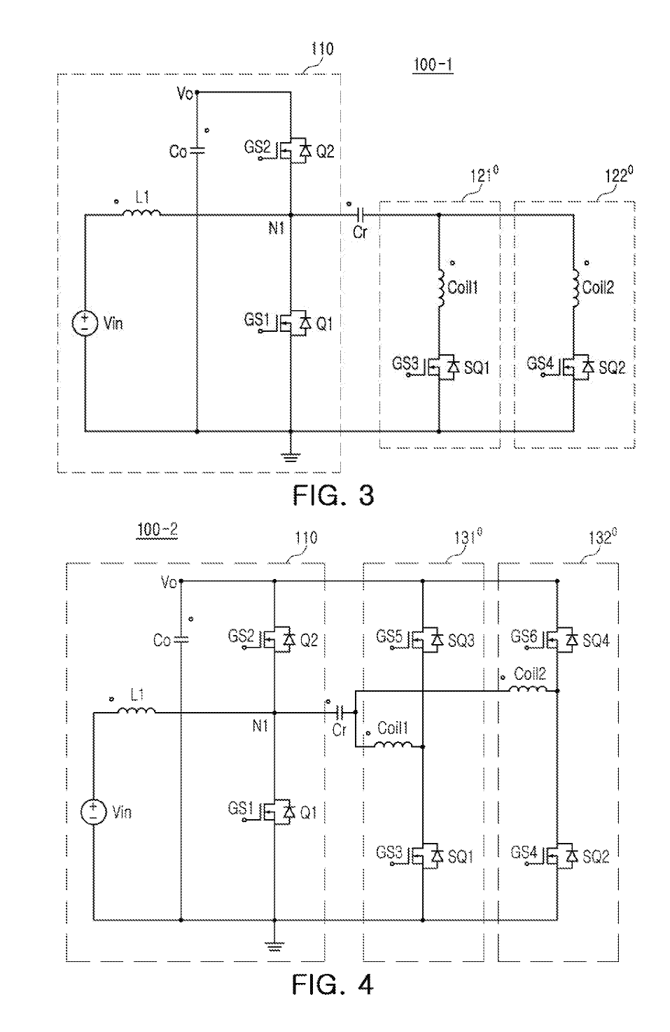

In addition, according to another embodiment, the resonance capacitor may be shared by the first and second resonators 121 and 122, thereby further saving the production costs. This embodiment will be described with reference to FIGS. 3 through 6.

FIG. 3 is a circuit diagram illustrating a wireless power transmitter 100-1, according to an embodiment. The wireless power transmitter 100-1 differs from the wireless power transmitter 100 illustrated in FIG. 2 in that the wireless power transmitter 100-1 further includes a common resonance capacitor Cr, and includes a first resonator 121^{} and a second resonator 122^{}. In the interest of conciseness, a description of features and characteristics of the wireless power transmitter 100-1 that overlaps with the description of the wireless power transmitter 100 will be omitted.

Referring to FIG. 3, the common resonance capacitor Cr includes one terminal connected to an AC node N1 between the first switch Q1 and the second switch Q2. Further, the first resonator 121^{} and the second resonator 122^{} are connected to another terminal of the common resonance capacitor Cr. Further, as compared to the wireless power transmitter 100 of FIG. 2, the resonance capacitor C1/C2 included in each of the first and second resonators 121 and 122 is replaced with the common resonance capacitor Cr.

FIG. 4 is a circuit diagram illustrating a wireless power transmitter 100-2, according to an embodiment. The wireless power transmitter differs from the wireless power transmitter 100-1 illustrated in FIG. 3 in that the wireless power transmitter 100-2 includes a first resonator 131^{} and a second resonator 132^{}. In the interest of conciseness, a description of features and characteristics of the wireless power transmitter 100-2 that overlaps with the description of the wireless power transmitter 100-1 of FIG. 3 will be omitted.

The first resonator 131^{} includes the first resonance coil Coil1, which is connected to the common resonance capacitor Cr and transmits power in a non-contact manner, the first sub-switch SQ1, and a third sub-switch SQ3. Similarly, the second resonator 132^{} includes the second resonance coil Coil2, which is connected to the common resonance capacitor Cr and transmits the power in the non-contact manner, the second sub-switch SQ2, and a fourth sub-switch SQ4. Further, the first sub-switch SQ1 is turned on or off by the third gate signal GS3, the third sub-switch SQ3 is turned on or off by a fifth gate signal GS5, the second sub-switch SQ2 is turned on or off by the fourth gate signal GS4, and the fourth sub-switch SQ4 is turned on or off by a sixth gate signal GS6. The first sub-switch SQ1 and the third sub-switch SQ3 are complementarily turned on or off (e.g., are turned on or off together), and the second sub-switch SQ2 and the fourth sub-switch SQ4 are complementarily turned on or off.

Further, the first and third sub-switches SQ1 and SQ3 are operated as a full-bridge circuit together with the first and second switch Q1 and Q2, and the second and fourth sub-switches SQ2 and SQ4 are operated as the full-bridge circuit together with the first and second switch Q1 and Q2.

The resonance capacitors C1 and C2 included in the first resonator 121 and the second resonator 122 in the embodiment of FIG. 2 are replaced with the common resonance capacitor Cr, similarly to the wireless power transmitter 100-1 illustrated in FIG. 3.

The common resonance capacitor Cr of the wireless power transmitters 100-1 and 100-2 described with reference to FIGS. 3 and 4 determines a resonance frequency for magnetically coupling with the wireless power receiver 200. Therefore, since the common resonance capacitor Cr generally has a low capacitance change due to a temperature change, it has good temperature characteristics, and a capacitor of a type (e.g., a COG type) having a low manufacturing capacitance deviation may be used. Further, such a type of capacitor may be relatively widely available.

In the wireless power transmitters 100-1 and 100-2, since each of the first and second resonators 121^{}/131^{} and 122^{}/132^{} does not require the resonance capacitor C1/C2 and the plurality of resonators share the common resonance capacitor Cr, the production costs may be further reduced and the first and second resonators 121^{}/131^{} and 122^{}/132^{} may have more uniform performance.

However, as the resonance capacitor C1/C2 is removed from each of the first and second resonators 121^{}/131^{} and 122^{}/132^{}, an unintended circulation of the current may occur. For example, it is assumed that only the first resonator 121^{} is driven for wirelessly transmitting the power and the second resonator 122^{} is not driven for wirelessly transmitting the power in the wireless power transmitter of FIG. 3.

In order to drive the first resonator 121^{}, the first sub-switch SQ1 is turned on and the alternating current flows in the resonance coil Coil1. In this case, the current may flow in a reverse direction through the diode of the second sub-switch SQ2 and may be circulated to the second resonator 122^{} which does not need to be driven, thereby causing the power to be wirelessly radiated by the second resonance coil Coil2.

The first resonance coil Coil1 and the second resonance coil Coil2 may be disposed adjacent to each other or disposed to overlap each other in at least some regions, and may be selectively operated according to a position of the wireless power receiver. By such an arrangement and operation, the wireless power transmitter 100-1 significantly reduces a depletion region that the power does not wirelessly reach, and provides a wide wireless chargeable region with the wireless power receiver 200. In a case in which the wireless power radiation occurs by the unintended resonance coil in the selective operation of the first resonance coil Coil1 and the second resonance coil Coil2, however, the power of the first resonance coil Coil1 and the second coil Coil2 may wirelessly interfere with each other, thereby reducing efficiency of a wireless charging.

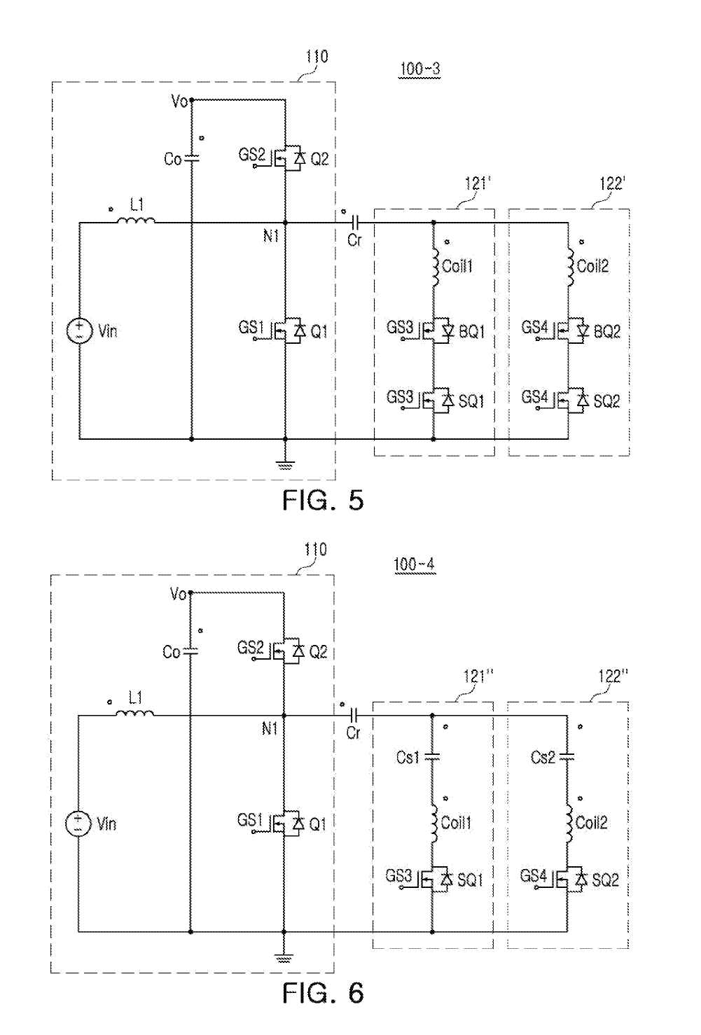

Hereinafter, examples of wireless power transmitters 100-3 and 100-4 that block the current circulated to resonance coils Coil1 and Coil2 will be described with reference to FIGS. 5 and 6. FIGS. 5 and 6 illustrate modified examples of the wireless power transmitter 100-1 of FIG. 3, but the wireless power transmitter 100-2 of FIG. 4 may also be modified in the same way.

FIG. 5 is a circuit diagram illustrating a wireless power transmitter 100-3, according to an embodiment.

Referring to FIG. 5, in order to prevent the above-mentioned problem, the wireless power transmitter 100-3 includes a first resonator 121′ including a first back-to-back switch BQ1, and a second resonator 122′ including a second back-to-back switch BQ2. The first back-to-back switch BQ1 and the second back-to-back switch BQ2 have a back-to-back function. That is, the first back-to-back switch BQ1 blocks a current circulated to the first resonance coil Coil1 when the first sub-switch SQ1 is turned off, and the second back-to-back switch BQ2 blocks a current circulated to the second resonance coil Coil2 when the second sub-switch SQ2 is turned off.

FIG. 6 is a circuit diagram illustrating a wireless power transmitter 100-4, according to another embodiment. The wireless power transmitter 100-4 differs from the wireless power transmitter 100-3 illustrated in FIG. 5 in that the wireless power transmitter 100-4 includes a first resonator 121″ and a second resonator 122″. A description of features and characteristics of the wireless power transmitter 100-4 that overlaps with the description of the wireless power transmitter 100-3 of FIG. 5 will be omitted.

Referring to FIG. 6, the first resonator 121″ and the second resonator 122″ include first and second series capacitors Cs1 and Cs2 instead of the first and second back-to-back switches BQ1 and BQ 2. That is, the first resonator 121″ includes the first series capacitor Cs1, which is connected in series with the first resonance coil Coil1, and the second resonator 122″ includes the second series capacitor Cs2, which is connected in series with the second resonance coil Coil2. Similarly to the first and second back-to-back switches BQ1 and BQ2, the first series capacitor Cs1 blocks a current circulated to the first resonance coil Coil1 when the first sub-switch SQ1 is turned off, and the second series capacitor Cs2 blocks a current circulated to the second resonance coil Coil2 when the second sub-switch SQ2 is turned off.

Since the wireless power transmitter 100-4 includes the first and second series capacitors Cs1 and Cs2 instead of the first and second back-to-back switches BQ1 and BQ2 to block the circulated current, production costs may be further reduced.

Capacitances of the first series capacitor Cs1 and the second series capacitor Cs2 may be at least 10 times greater than a capacitance of the common resonance capacitor Cr. Since the first capacitor Cs1 and the common resonance capacitor Cr are connected in series with each other and the second capacitor Cs2 and the common resonance capacitor Cr are connected in series with each other, capacitance of an overall capacitor that determines the resonance frequency of the wireless power may be determined by the capacitor having the smallest capacitance. That is, in a case in which the capacitances of the first series capacitor Cs1 and the second series capacitor Cs2 are sufficiently greater than the capacitance of the common resonance capacitor Cr, an influence of the capacitances on the resonance frequency may small and the resonance frequency of the first and second resonators 121″ and 122″ may be determined by the common resonance capacitor Cr.

As described above, a capacitor having a wide operational temperature range, good temperature characteristics, and a low manufacturing capacitance deviation may be used as the common resonance capacitor Cr. For example, the common resonance capacitor Cr may have a temperature rate of change of capacitance of 0±30 ppm/° C., and may have an operational temperature range of −55° C. to 125° C. Alternatively, the common resonance capacitor Cr may have the operational temperature range of −55° C. to 125° C., and may have a temperature rate of change of capacitance of ±15%.

Further, the first series capacitor Cs1 and the second series capacitor Cs2 may have a relatively narrower operational temperature range and a greater temperature rate of change of capacitance than the resonance capacitor Cr. For example, the first series capacitor Cs1 and the second series capacitor Cs2 may have the operational temperature range of −55° C. to 85° C., and may have the temperature rate of change of capacitance of ±15%.

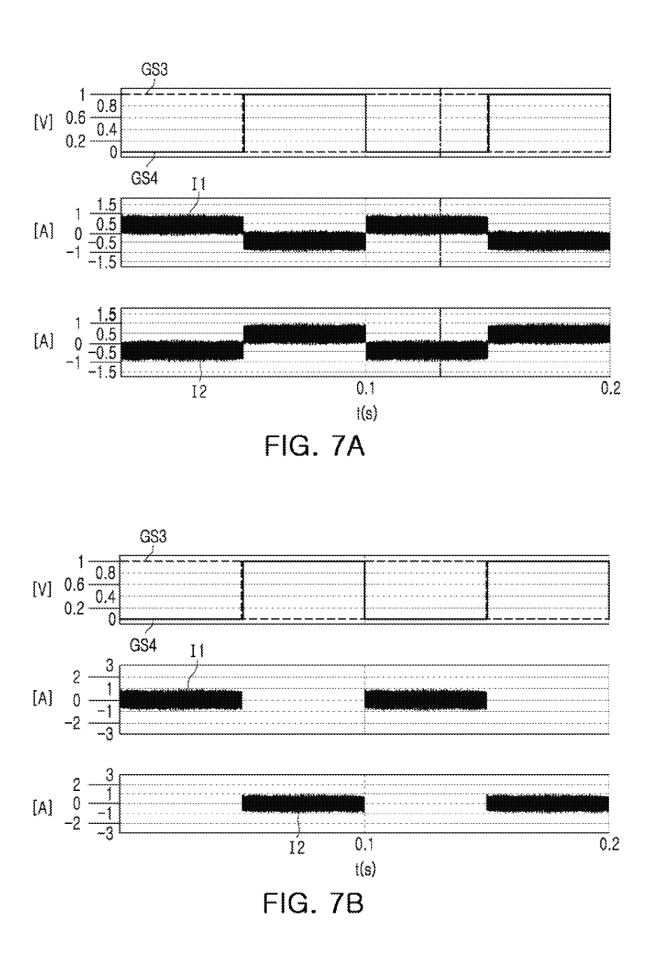

FIG. 7A is a graph illustrating a current circulating in a resonance coil. FIG. 7B is a graph illustrating a current the resonance coil of a wirelessly power transmitter, according to an embodiment disclosed herein.

Referring to FIGS. 3 through 7B, the third gate signal GS3 and the fourth gate signal GS4 alternately operate the first sub-switch SQ1 and the second sub-switch SQ2. Further, a current 11 flows in the first resonance coil Coil1 and a current 12 flows in the second resonance coil Coil2.

Referring to FIG. 7A, in a case of the wireless power transmitter 100-1 illustrated in FIG. 3 having a configuration without the first and second back-to-back switches BQ1 and BQ2, or the first and second series capacitors Cs1 and Cs2, when the first sub-switch SQ1 is turned off, the current circulated from the second resonance coil Coil2 flows in the first resonance coil Coil1, and when the first sub-switch SQ1 is turned off, the current circulated from the first resonance coil Coil1 flows in the second resonance coil Coil2.

On the other hand, referring to FIG. 7B, in a case of the wireless power transmitter 100-3 illustrated in FIG. 5 having the first and second back-to-back switches BQ1 and BQ2, or in a case of the wireless power transmitter 100-4 illustrated in FIG. 6 having the first and second series capacitors Cs1 and Cs2, when the first sub-switch SQ1 is turned off, the current circulated to the first resonance coil Coil1 is blocked and the current circulated to the second resonance coil Coil2 is blocked.

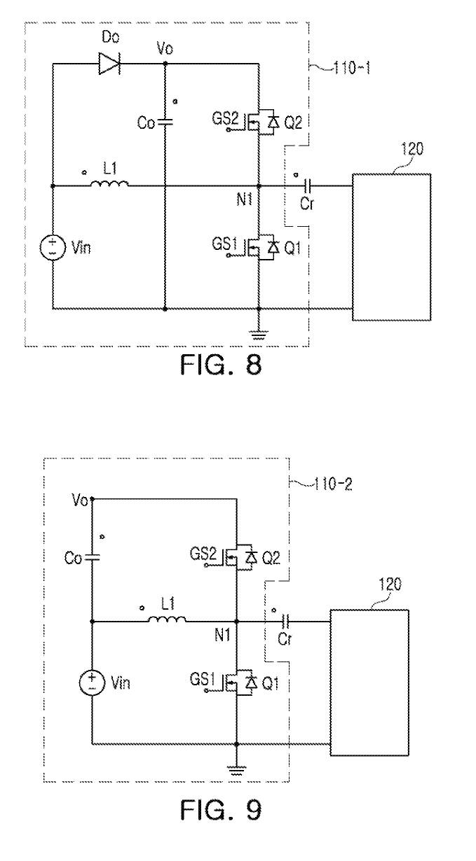

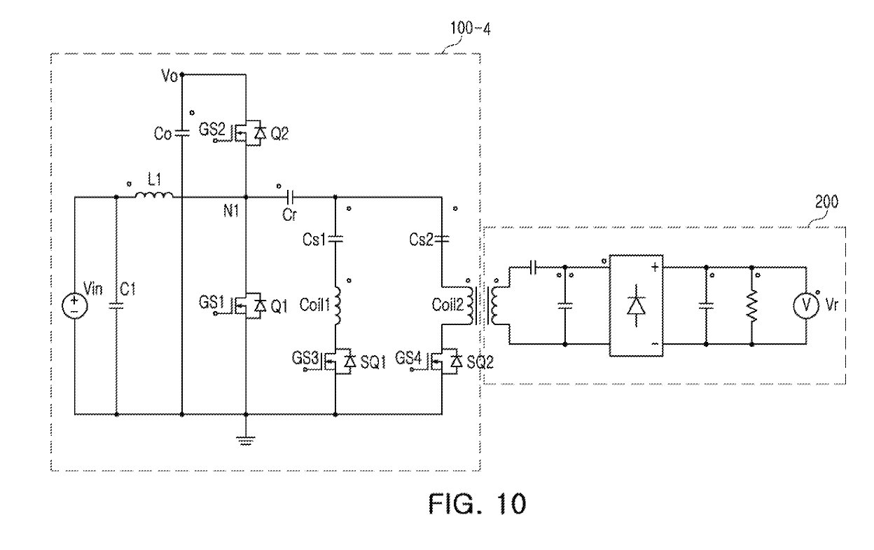

FIG. 8 is a circuit diagram illustrating a converter 110-1, according to an embodiment. FIG. 9 is a circuit diagram illustrating a converter 110-2, according to another embodiment.

As compared to the converter 110 described with reference to FIG. 2, the converter 110-1 differs in that it further includes an output diode Do, and the converter 110-2 illustrated in FIG. 9 differs in that the output capacitor Co and the input power are connected to each other. Further, resonators according to the previously described embodiments are collectively illustrated as a resonating unit 120. In the interest of conciseness, a description of components and features of the converters 110-1 and 110-2 that overlap with the description of the converter 110 in FIG. 2 will be omitted.

The converter 110 generates a transient response in which the output voltage Vo is unstably output by the resonance of the inductor L1 and the output capacitor Co in an initial operation section in which the voltage of the input power Vin is applied. FIGS. 8 and 9 illustrate examples for improving such a transient response.

Referring to FIG. 8, the converter 110-1 further includes the output diode Do connecting one terminal of the inductor L1 and one terminal of the output capacitor Co to each other. Since the voltage of the input power Vin immediately charges the output capacitor Co through the output diode Do in the initial operation section, the output diode Do suppresses the transient response in which the output voltage Vo is unstably output.

Further, referring to FIG. 9, in the converter 110-2, another terminal of the output capacitor Co is connected to the input power Vin. Similarly, since the voltage of the input power Vin immediately charges the output capacitor Co in the initial operation section by such a connection, the transient resonance in which the output voltage Vo is unstably output is improved.

According to another embodiment, the converter 110 is operated in a soft start mode in which an on-duty of the first switch Q1 is gradually increased at the time of an initial operation. In a case in which the converter 110 is operated in the soft start mode, a separate element or circuit connection for immediately charging the output capacitor Co with the voltage of the input power Vin may not be adopted.

FIG. 10 is a circuit of a wireless power transmission system to which the wireless power transmitter 100-4 described with reference to FIG. 6 is applied.

Referring to FIG. 10, the wireless power transmitter 100-4 is magnetically coupled to the wireless power receiver 200 to wirelessly transmit power. FIG. 10 illustrates a case in which the power is wirelessly radiated by the second resonance coil Coil2 and the first resonance coil Coil1 is not driven.

According to an embodiment, the first switch Q1 and the second switch Q2 are alternately operated at a duty ratio of 50%. Further, the first switch Q1 and the second switch Q2 are controlled in a pulse width modulation in which a turn-on duty is adjusted.

For example, in a case in which the on-duty ratio of the first switch Q1 is D (0<D<1) and the on-duty ratio of the second switch Q2 is 1−D, the output voltage Vo is Vi(1−D). In this case, Vi is the voltage of the input power Vi.

In a case in which the on-duty ratio D of the first switch Q1 is increased, the voltage of the input power Vin is boosted to a greater output voltage Vo, and a level of the AC voltage applied to the first and second resonators 121″ and 122″ is together increased. Even in a case in which a distance between the wireless power transmitter 100-4 and the wireless power receiver 200 is increased, the AC voltage having the increased level allows the wireless power receiver 200 to acquire a sufficient received voltage for wireless power charging.

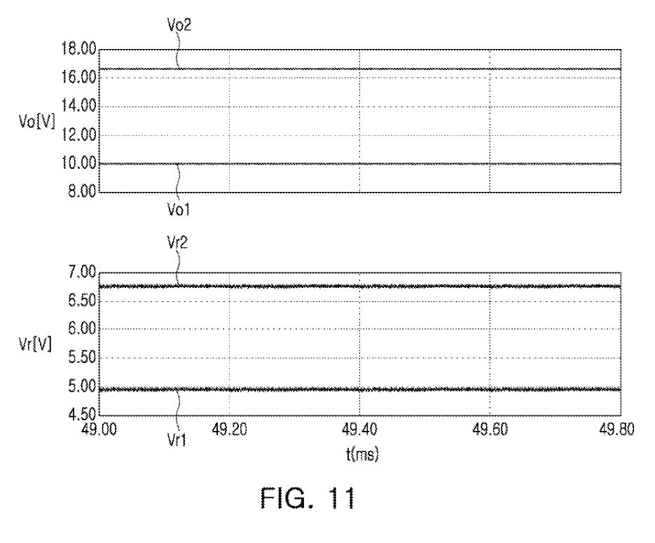

FIG. 11 is a graph illustrating an output voltage of the converter 110 and an output voltage of the wireless power receiver 200, according to an embodiment.

Referring to FIGS. 10 and 11, Vo1 is an output voltage in a case in which the first switch Q1 operates at an on-duty ratio of 50%, and Vo2 is the output voltage in a case in which the first switch Q1 operates at the on-duty ratio of 70%. It can be understood that, when the on-duty ratio of the first switch Q1 increases, a level of the output voltage Vo increases to 16.6V from 10V. Accordingly, it can be understood that a received voltage Vr obtained by the wireless power receiver 200 also increases to 6.7V (Vr2) from 5V (Vr1).

As set forth above, according to the embodiments disclosed herein, the wireless power transmitter can be more conveniently used by the user, such as by further widening the range in which the power can be wirelessly transmitted while satisfying all of the various limitations that need to be satisfied in wirelessly transmitting the power. At the same time, the wireless power transmitter can improve wireless power transmission efficiency.

Further, since the resonators disclosed herein share a common resonance capacitor, production costs can be reduced and the resonators can have more uniform performance.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A wireless power transmitter, comprising:
a converter comprising a first switch and a second switch, and configured to output alternating current (AC) power to an AC node between the first switch and the second switch;
a common resonance capacitor connected to the AC node; and
resonators connected to the common resonance capacitor,
wherein each of the resonators comprises a series capacitor, a resonance coil, and a sub-switch, connected to each other in series, and
wherein the resonance coil is configured to transmit the power in a non-contact manner.

2. The wireless power transmitter of claim 1, wherein the converter further comprises
an inductor comprising one terminal connected to input power and another terminal connected to the AC node, and
an output capacitor comprising one terminal connected to the second switch.

3. The wireless power transmitter of claim 2, wherein the converter further comprises an output diode connecting the one terminal of the inductor and the one terminal of the output capacitor to each other.

4. The wireless power transmitter of claim 2, wherein the converter comprises another terminal of the output capacitor connected to the one terminal of the inductor.

5. The wireless power transmitter of claim 1, wherein the series capacitor comprises a capacitance that is at least 10 times greater than a capacitance of the common resonance capacitor.

6. The wireless power transmitter of claim 1, wherein an operational temperature range of the common resonance capacitor is wider than an operational temperature range of the series capacitor.

7. The wireless power transmitter of claim 1, wherein a rate of change of capacitance according to temperature of the common resonance capacitor is lower than a rate of change of capacitance according to temperature of the series capacitor.

8. The wireless power transmitter of claim 1, wherein the converter is configured to be operated in a soft start mode in which an on-duty of the first switch is gradually increased at a time of an initial operation.

9. The wireless power transmitter of claim 1, wherein
the common resonance capacitor comprises a temperature rate of change of capacitance of 0±30 ppm/° C. and an operational temperature range of −55° C. to 125° C., and
the series capacitor comprises an operational temperature range of −55° C. to 85° C., and a temperature rate of change of capacitance of ±15%.

10. A wireless power transmitter, comprising:
an inductor connected between input power and an alternating current (AC) node;
a first switch connected between the AC node and a ground;
a second switch connected between the AC node and an output terminal;
a common resonance capacitor comprising one terminal connected to the AC node; and
resonators connected to another terminal of the common resonance capacitor,
wherein each of the resonators comprises a resonance coil configured to transmit power in a non-contact manner and a series capacitor.

11. The wireless power transmitter of claim 10, wherein the resonator further comprises a sub-switch configured to control the resonance coil.

12. The wireless power transmitter of claim 10, wherein
each of the resonators further comprises two sub-switches configured to control the resonance coil, and
the two sub-switches are configured to operate as a full-bridge circuit together with the first switch and the second switch.

13. The wireless power transmitter of claim 11, wherein each of the resonators further comprises a back-to-back switch configured to block a current circulated to the resonance coil when the sub-switch is turned off.

14. The wireless power transmitter of claim 10, wherein the series capacitor comprises a capacitance that is at least 10 times greater than a capacitance of the common resonance capacitor.

15. The wireless power transmitter of claim 10, wherein an operational temperature range of the common resonance capacitor is wider than an operational temperature range of the series capacitor.

16. The wireless power transmitter of claim 10, wherein a rate of change of capacitance according to a temperature of the common resonance capacitor is lower than a rate of change of capacitance according to a temperature of the series capacitor.

17. The wireless power transmitter of claim 10, wherein the first switch is configured to be operated in a soft start mode in which an on-duty is gradually increased when the input power is applied.

18. The wireless power transmitter of claim 10, wherein
the common resonance capacitor comprises a temperature rate of change of capacitance of 0±30 ppm/° C. and an operational temperature range of −55° C. to 125° C., and
the series capacitor comprises an operational temperature range of −55° C. to 85° C., and a temperature rate of change of capacitance of ±15%.
